(19) United States
(12) Patent Application Publication
(10) Pub. No.: US 2019/0139458 A1
(43) Pub. Date: May 9, 2019

(54) Key Labeling System and Method of Promotional Advertising through Distribution of Labeled Key Head Covers

(71) Applicant: LNK Innovations LLC, Los Angeles, CA (US)

(72) Inventor: Suzanne Parker, Los Angeles, CA (US)

(21) Appl. No.: 16/185,425

(22) Filed: Nov. 9, 2018

Related U.S. Application Data
(60) Provisional application No. 62/584,062, filed on Nov. 9, 2017.

(51) Int. Cl. G09F 3/02; E05B 19/24; G09F 3/18; G09F 23/00; G06Q 99/00

(52) U.S. Cl. CPC G09F 3/02; E05B 19/24; G06Q 99/00; G09F 23/00; G09F 3/18

(57) ABSTRACT

A key labeling system and method of promotional advertising through distribution of labeled key head covers enables free distribution of a labeled key head cover to potential consumers for personal use, whereby, the potential consumer frequently views advertisements, messages, and logos that display on the key. The method is also marketed to promotional catalogues. The labeled key head cover comprises a circular-shaped sleeve having a first face, a second face, an inner cavity for retaining the key head, a through opening to fit around the key head, and a resilient material fitting around the key head. The first face comprises a printed promotional indicia that can include: an advertisement, a contact identifier, a promotion, a trademark, a product name, a business name, and a logo. A gap forms in the second face of sleeve for receiving and viewing an insert label that can be marked and customized by the consumers.

### CROSS REFERENCE OF RELATED APPLICATIONS

This application claims the benefits of U.S. provisional application No. 62/584,062, filed Nov. 9, 2017 and entitled METHOD OF PROMOTIONAL ADVERTISING THROUGH DISTRIBUTION OF LABELED KEY HEAD COVERS, which provisional application is incorporated by reference herein in its entirety.

### FIELD OF THE INVENTION

The present invention relates generally to a key labeling system and method of promotional advertising through distribution of labeled key head covers. More so, a promotional advertising method enables efficient and free distribution of a labeled key head cover to a consumer that is within easy, daily use, such that the potential consumers frequently views an advertisement, message, or logo displayed on the key; whereby the method of promotional advertising may be marketed to promotional catalogues for promotional use among other promotional uses; whereby the labeled key head cover comprises a generally circular-shaped sleeve defined by a first face, a second face, an inner cavity for retaining the head of the key, a through opening to fit around the head end of the key, and a resilient material of a size to fit around the key head; whereby the first face comprises a printed promotional indicia including at least one of the following: an advertisement, a contact identifier, a promotion, a trademark, a product name, a business name, and a logo; whereby a gap forms in the second face for receiving an insert label that can be marked upon by the potential consumer.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a key includes a small piece of metal consisting of two parts: the blade, which slides into the keyway of the lock and distinguishes between different keys, and the head, or bow, which is left protruding so that torque can be applied by the user.

In many instances, the elongated, sharded configuration of a key causes the keys to look similar to each other. This can cause confusion when carrying multiple keys. Thus, conventional key labels metal-rimmed paper disks, can be affixed to keys with key rings. Another type of conventional key label, for example, key head covers, are designed to fit a limited number of key head shapes, but to not work well for all shapes of key heads. Often, key head covers may include resilient sleeves with markings used to distinguish different keys through various indicia, colors, and textures. Labels may also be affixed to the head of the key to provide a markable surface for adding customized information onto the key by the consumer.

Generally, companies and organizations have a goal to cost-effectively increase sales of their goods or services with minimal marketing costs. For example, in promotional advertising an advertiser distributes to potential consumers, some free promotional item bearing a display advertisement associated with the advertiser's products or services. The distribution is conducted in person, at an event, or by mail. The rationale underlying promotional advertising is that potential consumers having received a free gift, will retain that gift for their personal use and as a consequence would frequently see the advertisement displayed thereupon.

Typically, a primary consideration for advertising is an advertiser's ability to accurately assess the interests of a group of potential consumers and to select the type of promotional items, reference information and ads, accordingly. Ultimately, an advertiser would like to be assured that each individual having received a promotional item would retain that item for subsequent reference and use.

Other proposals have involved inexpensive marketing methods. The problem with these marketing methods is that they do not allow for regular viewing by a consumer. Also, the marketing material is not within reach of the consumer every day. Even though the above cited marketing methods meet some of the needs of the market, a key labeling system and method of promotional advertising through distribution of labeled key head covers provides efficient and free distribution of a labeled key head cover to a consumer that is within easy, daily use, such that the potential consumers frequently views an advertisement, message, or logo displayed on the key, is still desired.

### SUMMARY

Illustrative embodiments of the disclosure are generally directed to a key labeling system and method of promotional advertising through distribution of labeled key head covers. In some embodiments, the key labeling system and method utilizes a key head cover for effective promotional advertising means, marking personal information, and creating texture on the head of a key. In this manner, it is possible to freely distribute a labeled key head cover to potential consumer for personal use. In this manner, the potential consumer frequently views an advertisement displayed on the key.

In other embodiments, the method is marketed to promotional catalogues for promotional use. The labeled key head cover comprises a circular-shaped sleeve defined by a first face, a second face, an inner cavity for retaining the key head, a through opening to fit around the key head, and a resilient material fitting around the key head. The first face comprises a printed promotional indicia that can include: an advertisement, a contact identifier, a promotion, a trademark, a product name, a business name, and a logo. A gap forms in the second face of sleeve for receiving and viewing an insert label that can be marked and customized by the consumers

The method may include an initial Step of fabricating a labeled key head cover comprising a sleeve defined by a first face, a second face, an inner cavity for retaining the head of a key, a through opening to fit around a head of the key, the labeled key head cover being defined by a resilient material expandable around the key head.

The method may further comprise a Step of printing a printed promotional indicia on the first face of at least one of the following: an advertisement, a contact identifier, a promotion, a trademark, a product name, a business name, and a logo.

A Step includes distributing the labeled key head cover to a potential consumer.

In some embodiments, a Step comprises marketing the labeled key head cover to at least one promotional catalogue for promotional use.

A Step includes affixing, by the potential consumer, the labeled key head cover to a key.

In some embodiments, a Step may include attaching, by the potential consumer, an insert label to the labeled key head cover, whereby the potential consumer marks the insert label with information.

A Step comprises viewing, by the potential consumer, the printed promotional indicia on the labeled key head cover during regular use of the key.

The method may further comprise a Step of viewing, by the potential consumer, the promotional catalogue advertising the labeled key head cover.

A Step includes responding to inquiries about the printed promotional indicia from the potential consumer.

A final Step includes conducting a transaction for an event, product, or service based at least partially on the printed promotional indicia.

In another aspect, the indicia comprises printed promotional indicia.

In another aspect, the step of distributing the labeled key head cover to a potential consumer, further comprises distributing the labeled key head cover as a free gift.

In another aspect, the distribution of the labeled key head cover is conducted in person, at an event, or by mail.

In another aspect, the method further comprises a step of setting up a distribution point for distributing the labeled key head cover.

In another aspect, the step of affixing, by the potential consumer, the labeled key head cover to a key, further comprises passing the head of the key through the through opening in the sleeve, and encapsulating the key head.

In another aspect, the step of responding to inquiries about the printed promotional indicia from the potential consumer, further comprises answering phone calls from the potential consumers.

In another aspect, the method is operational with organizations, corporations, government entities, individual consumers, and the general public.

One objective of the present invention is to utilize a key head cover for effective promotional advertising means, marking personal information, and creating texture on the head of a key.

Another objective is to provide a labeled key head cover that affixes to a standard key 300, as known in the art, and that is commonly used by potential consumers on a daily basis.

Another objective is to provide a labeled key head cover that has prominently displayed a printed promotional indicia.

Another objective is to provide a promotional accessory, such as a key head cover 214 that is used and viewed often by potential consumers.

Another objective is to increase in sales and revenue, net of advertising costs, with minimal expenditures.

Another objective is to provide an easy to use method of promotional advertising through distribution of labeled key head covers.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary key labeling system for promotional advertising, in accordance with an embodiment of the present invention;

FIG. 2 illustrates a flowchart of an exemplary method of promotional advertising through distribution of labeled key head covers, in accordance with an embodiment of the present invention;

FIGS. 3A-3C illustrate the sequential steps through which the insert label marked with information is applied to the second face of the key, whereby FIG. 3A shows the key, FIG. 3B shows the insert label being adhered to the key head, and FIG. 3C shows the sleeve encapsulating the key head, in accordance with an embodiment of the present invention;

FIGS. 4A and 4B illustrates a first face and a second face of the labeled key head cover, in accordance with an embodiment of the present invention;

FIG. 5 illustrates a first face of the sleeve for the labeled key head cover, showing promotional indicia, in accordance with an embodiment of the present invention; and

FIG. 6 illustrates a second face of the sleeve for the labeled key head cover, showing insert label viewable through a gap, in accordance with an embodiment of the present invention.

Like reference numerals refer to like parts throughout the various views of the drawings.

### DETAILED DESCRIPTION OF THE INVENTION

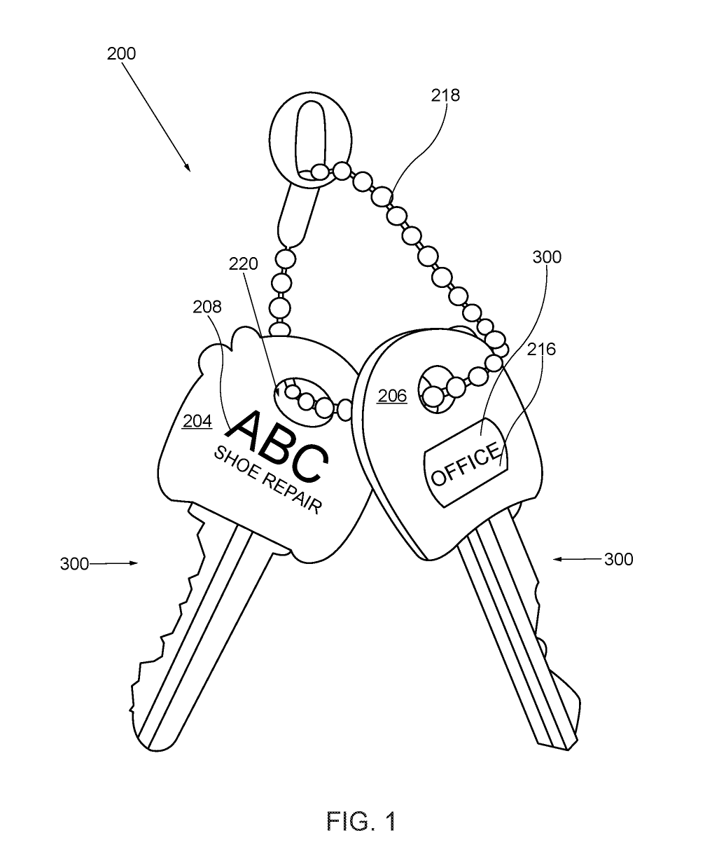

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention presented in FIGS. 1-6, a key labeling system 200 and method 100 of promotional advertising through distribution of labeled key head covers provides a process for marketing and promoting events, products, and services through targeted distribution of a labeled key head cover 214 that has prominently displayed thereon, a printed promotional indicia 208 and a customizable insert label 212.

The key labeling system 200 and method 100 allows for targeted and free distribution of the labeled key head cover 214 to potential consumers for their personal use; and as a consequence, the potential consumers frequently views the printed promotional indicia 208 displayed on the labeled key head cover 214 through regular use of the key 300. The method 100 is also an effective means to market to promotional catalogues, or simply for informing potential consumers about an event, product, or service.

As referenced in FIG. 1, the key labeling system 200, hereafter “system 200” is configured with a labeled key head cover 214 that affixes to a standard key 300, as known in the art, and that is commonly used by potential consumers on a daily basis. The labeled key head cover 214 provides a vehicle for transmitting promotional information and advertisements to a potential consumer who used a key 300. The labeled key head cover 214 is sufficiently resilient to be detachably attachable to the key, easily encapsulating the key head 302 because of a resilient material that stretches to pull over and encapsulate the head 302 of the key 300. In this manner, the labeled key head cover 214, with promotional indicia 208 displayed therefrom, is retained and viewed by the potential consumer while using the key 300 in regular operation of the key 300.

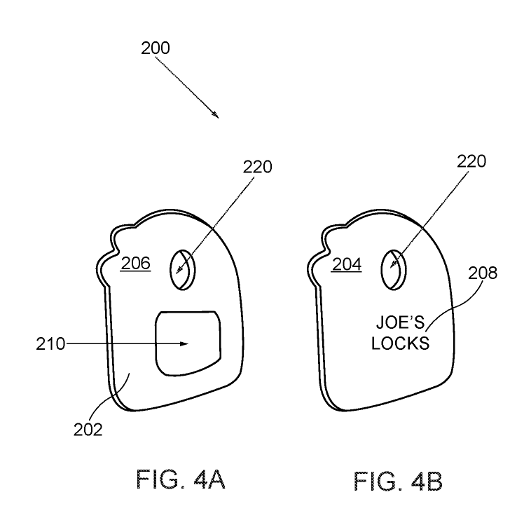

Looking ahead to FIGS. 4A and 4B, the labeled key head cover 214 comprises a generally circular-shaped sleeve 202 defined by a first face 204, a second face 206, an inner cavity 222 for retaining the head 302 of the key 300, a through opening 220 to fit around the head 302 of the key 300. A mounting member 218, such as a chain or cable, may pass through the through opening 220 to enable mounting of the system 200 to a mounting surface, such as a nail or peg.

In some embodiments, the sleeve 202 may be formed from a resilient material of a size to fit around the key head 302. The first face 204 of the sleeve 202 is defined by a printed promotional indicia 208 comprising at least one of: an advertisement, a contact identifier, a promotion, a trademark, a product name, a business name, and a logo.

In some embodiments, the second face 206 of the sleeve 202 forms a gap 210. The gap 210 is configured to receive and enable viewing of the insert label 212 that can be marked upon by the potential consumer. In one possible embodiment, the gap 210 is defined by a peripheral edge, whereby the gap 210 is adapted to receive the insert label 212 having an insert peripheral edge, such that the insert peripheral edge is immediately adjacent to the peripheral edge of the gap 210. Though in other embodiments, the insert label is simply adhered to the key head 302 and visible through the gap 210.

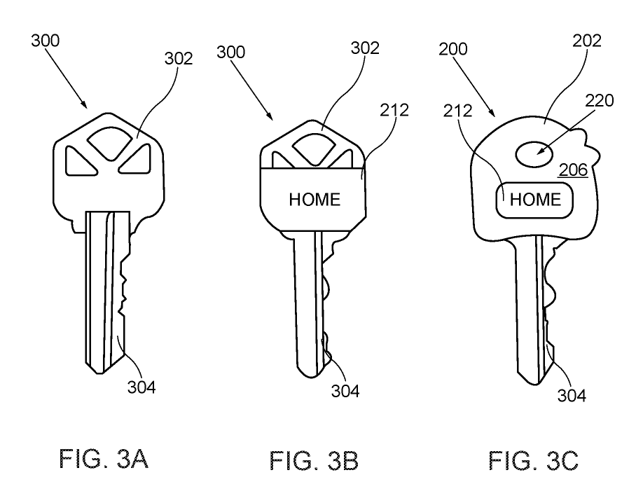

Those skilled in the art will recognize that a key 300 is a device that is used to operate a lock, such as to lock or unlock it. As FIG. 3A illustrates, a typical key 300 often includes a small piece of metal consisting of two parts: the blade 304, which slides into the keyway of the lock and distinguishes between different keys, and the head 302, or bow, which is left protruding so that torque can be applied by the user.

Often, keys look similar, and must thus be labeled. Conventional key labels, for example, metal-rimmed paper disks, are often attached to keys with key rings. Another type of conventional key label, for example, key head covers, are designed to fit a limited number of key head shapes, but to not work well for all shapes of key heads. Looking again at FIG. 1, the key head covers may include resilient sleeves with markings used to distinguish different keys through various indicia, colors, and textures. Labels may also be affixed to the head of the key to provide a markable surface for adding customized information onto the key by the consumer.

It is also known in the art that in the fields of marketing and advertising, the goal of advertisers is to cost-effectively increase sales of their goods or services. In promotional advertising an advertiser distributes to potential consumers, some free promotional item bearing a display advertisement associated with the advertiser's products or services. The distribution is conducted in person, at an event, or by mail. The rationale underlying promotional advertising is that potential consumers having received a free gift, will retain that gift for their personal use and as a consequence would frequently see the advertisement displayed thereupon.

The effectiveness of a promotional advertising campaign generally depends on many of the same factors as does direct mail advertising. A key factor in each, is an advertiser's ability to accurately assess the interests of a group of potential consumers and to select the type of promotional items, reference information and ads, accordingly. Ultimately, an advertiser would like to be assured that each individual having received a promotional item would retain that item for subsequent reference and use.

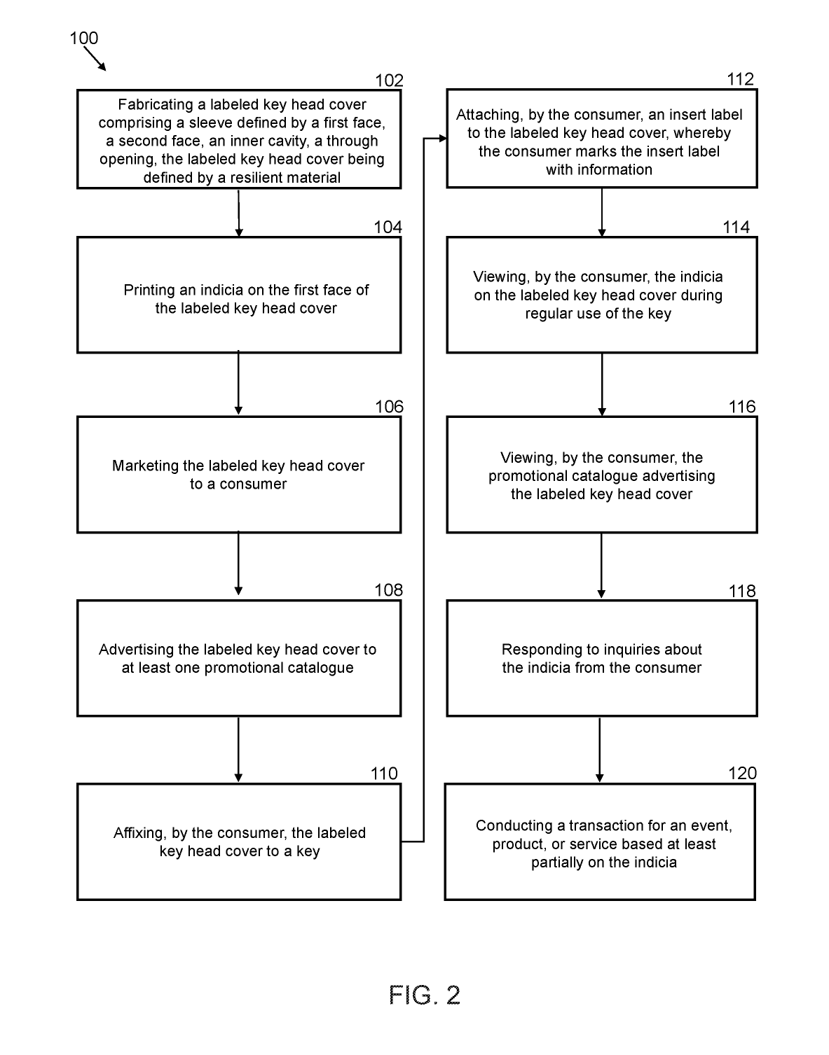

Looking now at FIG. 2, the method 100 of promotional advertising through distribution of labeled key head covers may include an initial Step 102 of fabricating a labeled key head cover 214 comprising a sleeve 202 defined by a first face 204, a second face 206, an inner cavity 222, a through opening 220, the labeled key head cover being defined by a resilient material.

The method 100 may further comprise a Step 104 of printing an indicia on the first face of the labeled key head cover. The indicia may including marketing and messaging data, including, without limitation, an advertisement, a contact identifier, a promotion, a trademark, a product name, a business name, and a logo. This information helps promote an event, service, or product.

A Step 106 includes marketing the labeled key head cover to a consumer. The step of distributing the labeled key head cover to a potential consumer, further comprises distributing the labeled key head cover as a free gift. The distribution of the labeled key head cover may be conducted in person, at an event, or by mail. Another Step 108 may include advertising the labeled key head cover to at least one promotional catalogue. The catalogue provides yet another means of exposing the indicia 208 on the key head cover 214.

In some embodiments, a Step 110 comprises affixing, by the consumer, the labeled key head cover to a key. The sleeve is resilient, so it can be stretched over the head of the key. This may require prying the edges of the sleeve to accommodate the circumference of the key head.

In some embodiments, a Step 112 may include attaching, by the consumer, an insert label to the labeled key head cover, whereby the consumer marks the insert label with information. The insert label 212 may be marked upon by potential consumers with information 216, so as to pride customized information directly on the key 300. For example, the consumer may mark the insert label 212 with information 216, such as a room number, a building type, a person's name, a vehicle type, and a code

The method 100 may include another Step 114 may include, viewing, by the consumer, the indicia on the labeled key head cover during regular use of the key. For example, the consumer opens a door and views the indicia 208, showing a logo or a promotion for a pizza restaurant or a plumber. In some embodiments, a Step 116 comprises viewing, by the consumer, the promotional catalogue advertising the labeled key head cover. The catalogue is also useful for drawing the interest of the consumer, as the key head cover and indicia 208 thereon, are displayed for viewing.

A Step 118 comprises responding to inquiries about the indicia from the consumer. The indicia may often have a contact number, address, or email. If the consumer requests information, the consumer can make contact, and receive information based on the contact information and messaging of the indicia. A final Step 120 includes conducting a transaction for an event, product, or service based at least partially on the printed promotional indicia. After receiving the requested information, the consumer (or merchant) can conduct a transaction, such as buying the good or service advertised with the indicia. However, the method 100 is operable with any transaction known in the art, which is directly or indirectly affected by the indicia 208 or information 216 on the key head cover 214.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

As referenced in the first face shown in FIG. 4B, the first face 204 of the sleeve 202 is preprinted with identifying information used in the method 100. This allows for efficient and free distribution of marketing material or general information on a labeled key head cover 214 to the potential consumers for personal use. The ease of affixing the cover 200 around the head 302 of the key 300, and then viewing the promotional indicia 208 printed thereon creates an effective marketing tool. As a consequence, the potential consumers frequently views advertisement that is prominently displayed on the labeled key head cover 214. As a further potential use of the method 100, the labeled key head cover 214 may be marketed to promotional catalogues to create unique marketing opportunities.

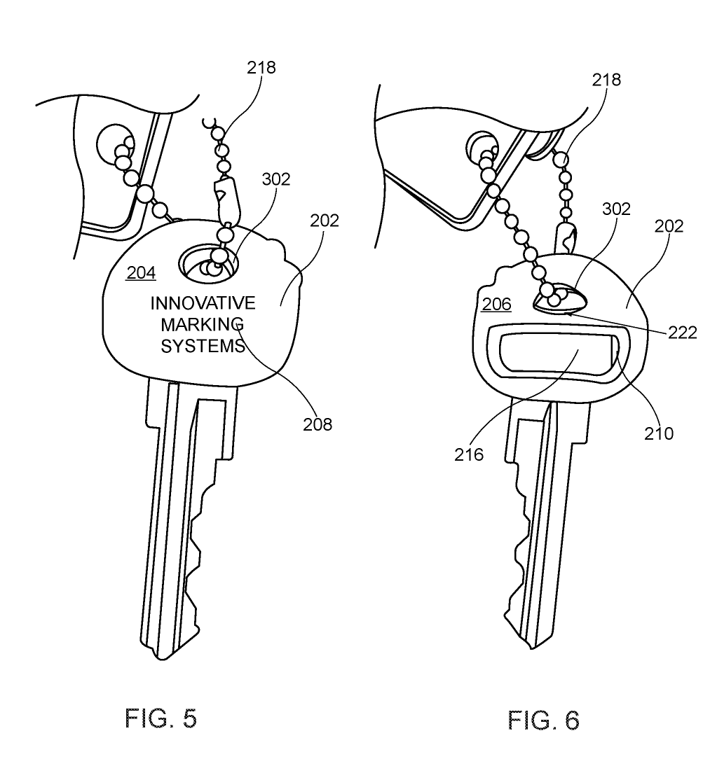

Turning now to FIG. 5, the labeled key head cover 214 comprises a circular-shaped sleeve 202. However in other embodiments, the sleeve 202 may be elongated, rectangular, triangular, or block-shaped, depending on the shape of the key head 302. The sleeve 202 may be defined by a first face 204 (FIG. 4B), a second face 206 (FIG. 4A), an inner cavity 222 for retaining the head of the key, a through opening 220 to fit around the key head, and a resilient material fitting around the key head.

Suitable materials for the sleeve 202 may include, without limitation, a polyester, plastic, resin, polyolefin, polyvinyl chloride, polytetrafluoroethylene (Teflon™), polychloroprene (Neoprene™), or the like. In some embodiments, the sleeve 202 may be colored white, red, blue, green, yellow, or other color. This variation in color also provides the advantage of enabling a user to distinguish between numerous similarly sized and dimensioned keys.

Looking again at FIG. 5, the first face 204 of the sleeve 202 may be preprinted with identifying information, formed with a flat surface so as to be written on. The first face 204 comprises a printed promotional indicia 208. In some embodiments, the first face 204 may include a printed promotional indicia 208. The indicia 208 may include, without limitation, an advertisement, a contact identifier, a promotion, a trademark, a product name, a business name, and a logo. It is significant to note that the indicia 208 is not limited to putting text onto the key caps. The indicia 208 can also be engraved, printed, etched, or marked in any manner known in the art on the first face 204 of the key head cover 214.

It is this printed promotional indicia 208 that allows the labeled key head cover 214 to be an effective promotional tool, because as the potential consumer uses the key 300, the printed promotional indicia 208 is visible to the consumer on the sleeve 202. This acts as a subliminal reminder about the event, product, or service printed thereon. Also, a separate catalogue can be used to advertise the system 200, which provides yet another avenue for displaying the indicia 208. The catalogue can be printed, digital, or word-of-mouth. The catalogue is available to the public or to a private trade group. The catalogue can be printed to sell keys, key head covers, or any related products or services.

Turning now to FIG. 6, the second face 206 of the sleeve 202 is similar to the first face 204, with the exception of a gap 210 that forms thereon. The gap 210 is sized and dimensioned to receive and enable viewing of an insert label 212. The insert label 212 may be marked upon by potential consumers with information 216, so as to pride customized information directly on the key 300. However, in one alternative embodiment, the insert label 212 may be adhered to the first face 204 of the sleeve 202.

For example, the consumer may mark the insert label 212 with information 216, such as a room number, a building type, a person's name, a vehicle type, and a code. Though any information 216 may be marked on the insert. The insert label 212 is effective for enabling customized labeling of the key 300. This creates greater utility to the potential consumer, which enables more opportunities for the consumer to view the printed promotional indicia 208.

FIGS. 3A-3C illustrate the sequential steps through which the insert label 212 is applied to the second face 206 of the key. Thus, FIG. 3A shows the key; FIG. 3B shows the insert label being adhered to the key head 302; and FIG. 3C shows the sleeve encapsulating the key head 302. Initially, the key 300 is bare. The insert label 212 may be adhered to the second face 206 of the head 302 and marked upon by the consumer as desired. As illustrated, information 216, i.e. “Home”, is shown to be marked on the insert label 212. This information 216 can indicate that the key is used to open a front door of the consumer's house, for example.

The sleeve 202 is sufficiently resilient to be pried over the key head 302, creating a snug, yet detachable fit thereon. After the sleeve 202 is pulled over the head 302, the insert label 212 is visible through the gap 210 in the second face 206 of the sleeve 202. Thus, the printed promotional indicia 208 is visible from the first face 204, and the insert label 212 is visible through the gap 210 in the second face 206, providing dual functionality to the labeled key head covers.

In conclusion, the key labeling system 200 and method 100 of promotional advertising through distribution of labeled key head covers enables free distribution of a labeled key head cover 214 to potential consumers for personal use, whereby, the potential consumer frequently views an advertisement displayed on the key 300. The method is marketed to promotional catalogues for promotional use.

Continuing, the labeled key head cover 214 may have a circular-shaped sleeve 212. The sleeve 212 is defined by a first face 204 that displays the indicia, and a second face that displays marked information on an insert label. The sleeve is also defined by an inner cavity 222 for retaining the key head in a snug fit by prying open the edges of the sleeve at a through opening 220. Thus the sleeve can fit around the key head because it is fabricated from a resilient material that snugly fits around the key head.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A method of promotional advertising through distribution of labeled key head covers, the method comprising:
fabricating a labeled key head cover comprising a sleeve defined by a first face, a second face, an inner cavity, a through opening, the labeled key head cover being defined by a resilient material;
printing an indicia on the first face of the labeled key head cover;
marketing the labeled key head cover to a consumer;
advertising the labeled key head cover to at least one promotional catalogue;
affixing, by the consumer, the labeled key head cover to a key;
attaching, by the consumer, an insert label to the labeled key head cover, whereby the consumer marks the insert label with information;
viewing, by the consumer, the indicia on the labeled key head cover during regular use of the key;
viewing, by the consumer, the promotional catalogue advertising the labeled key head cover;
responding to inquiries about the indicia from the consumer; and
conducting a transaction for an event, product, or service based at least partially on the indicia.

2. The method of claim 1, wherein the indicia comprises printed promotional indicia.

3. The method of claim 1, further comprising a step of distributing the labeled key head cover to the consumer.

4. The method of claim 3, wherein the step of distributing the labeled key head cover further comprises distributing the labeled key head cover as a free gift.

5. The method of claim 4, wherein the distribution of the labeled key head cover is conducted in person, at an event, or by mail.

6. The method of claim 1, further comprising a step of setting up a distribution point for distributing the labeled key head cover.

7. The method of claim 1, wherein the step of affixing, by the consumer, the labeled key head cover to a key, further comprises passing the head of the key through the through opening, such that the key head is encapsulated by the sleeve.

8. The method of claim 1, wherein the step of responding to inquiries about the indicia from the consumer, further comprises answering phone calls from the consumer.

9. The method of claim 1, wherein the method is operable by at least one of the following:
an organization, a corporation, a government entity, an individual consumer, and the general public.

10. The method of claim 1, further comprising a step of passing a mounting member through the through opening.

11. A method of promotional advertising through distribution of labeled key head covers, the method comprising:
fabricating a labeled key head cover comprising a sleeve defined by a first face, a second face, an inner cavity for retaining the head of a key, a through opening to fit around a head of the key, the labeled key head cover being defined by a resilient material expandable around the key head;
printing a printed promotional indicia on the first face of at least one of the following: an advertisement, a contact identifier, a promotion, a trademark, a product name, a business name, and a logo;
distributing the labeled key head cover to a potential consumer;
marketing the labeled key head cover to at least one promotional catalogue for promotional use;
affixing, by the potential consumer, the labeled key head cover to a key;
attaching, by the potential consumer, an insert label to the labeled key head cover, whereby the potential consumer marks the insert label with information;
viewing, by the potential consumer, the printed promotional indicia on the labeled key head cover during regular use of the key;
viewing, by the potential consumer, the promotional catalogue advertising the labeled key head cover;
responding to inquiries about the printed promotional indicia from the potential consumer;
conducting a transaction for an event, product, or service based at least partially on the printed promotional indicia; and
setting up a distribution point for distributing the labeled key head cover.

12. The method of claim 11, wherein the step of distributing the labeled key head cover to a potential consumer, further comprises distributing the labeled key head cover as a free gift.

13. The method of claim 12, wherein the distribution of the labeled key head cover is conducted in person, at an event, or by mail.

14. The method of claim 11, wherein the step of affixing, by the consumer, the labeled key head cover to a key, further comprises passing the head of the key through the through opening, such that the key head is encapsulated by the sleeve.

15. The method of claim 11, wherein the step of responding to inquiries about the printed promotional indicia from the potential consumer, further comprises answering phone calls from the potential consumers.

16. The method of claim 11, wherein the method is operable by at least one of the following: an organization, a corporation, a government entity, an individual consumer, and the general public.

17. The method of claim 11, further comprising a step of passing a mounting member through the through opening.

18. A key labeling system, the system comprising:
a labeled key head cover for detachably covering a key, the labeled key head cover comprising:
a generally circular-shaped sleeve defined by a first face, a second face, an inner cavity for retaining a head of a key, and a through opening to fit around the head of the key, the sleeve further defined by a resilient material of a size to fit around the head of the key,
the first face of the sleeve being defined by a printed promotional indicia, the printed promotional indicia including at least one of the following: an advertisement, a contact identifier, a promotion, a trademark, a product name, a business name, and a logo,
the second face of the sleeve forming a gap defined by a peripheral edge, the gap being configured to receive an insert label having an insert peripheral edge, the insert label being markable with information, the gap being adapted to receive the insert label, whereby the insert peripheral edge of the insert label is immediately adjacent to the peripheral edge of the gap.

19. The system of claim 18, further comprising a mounting member passing through the through opening.

20. The system of claim 18, wherein the mounting member is a chain.
